(19) United States
(12) Patent Application Publication
(10) Pub. No.: US 2026/0104918 A1
(43) Pub. Date: Apr. 16, 2026

(54) SYSTEM AND METHOD FOR PRIORITIZING AMONG BUILT-IN AND PLUG-IN CAPABILITIES OF PLURAL ARTIFICIAL INTELLIGENCE PRODUCTIVITY TOOL SOFTWARE APPLICATIONS

(71) Applicant: Dell Products LP, Round Rock, TX (US)

(72) Inventors: Srikanth Kondapi, Austin, TX (US); Daniel L. Hamlin, Round Rock, TX (US); Balasingh Ponraj Samuel, Round Rock, TX (US)

(73) Assignee: Dell Products LP, Round Rock, TX (US)

(21) Appl. No.: 18/916,065

(22) Filed: Oct. 15, 2024

(51) Int. Cl. G06F 9/48; G06F 9/445

(52) U.S. Cl. CPC G06F 9/4881; G06F 9/44526

(57) ABSTRACT

A system and method of prioritizing among built-in and plug-in capabilities executed at the information handling system includes a hardware processing device and a data storage device, where the hardware processor executes computer-readable program code instructions of plural artificial intelligence (AI) productivity tool software modules from a manufacturer and a software vendor to receive a user query input and invoke a plurality of machine learning model algorithms to identify a plurality of responsive capabilities from built-in AI productivity tool-enablable software and plug-in AI productivity tool-enablable software. The hardware processor executes a capability orchestrator software application to rank each of the plurality of responsive capabilities based on a confidence score and prioritize each of the ranked plurality of capabilities from the confidence score and policy metadata identifying requirements of execution for at least one responsive capability to identify at least one responsive capability intent action to the use input.

### FIELD OF THE DISCLOSURE

The present disclosure generally relates to execution of computer-readable program code instructions for one or more artificial intelligence (AI) productivity tools. The present disclosure more specifically relates systems and methods of prioritizing among built-in and plug-in capabilities used by plural AI productivity tools to execute capability intent actions.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more workspace productivity applications such as for teleconferencing, word processing, sales systems, business software, gaming applications, or the like.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system that includes plural AI productivity tools coordinated to select among a plurality of AI productivity tool-enablable software applications for software services, operations, or responses of those AI productivity tool-enablable software applications responsive to a user-query input according to an embodiment of the present disclosure;

FIG. 2 is a graphic and block diagram illustrating an information handling system that includes plural AI productivity tools coordinated to select among a plurality of AI productivity tool-enablable software applications for software services, operations, or responses of those AI productivity tool-enablable software applications to a user-query input according to another embodiment of the present disclosure; and

FIG. 3 is a flow diagram showing a method of prioritizing among built-in and plug-in capabilities associated with a plurality of AI productivity tool-enablable software applications to execute capability intent actions from plural AI productivity tools pursuant to a user-query input according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Artificial intelligence (AI) is a developing technology that is used to increase the efficiency of computing systems and humans alike. The information handling system of embodiments of the present disclosure may include AI productivity tools that interface with various AI productivity tool-enablable software applications that increase the efficiency of the operation of the information handling system. An example of AI technologies includes, but is not limited to, computer-readable program code instructions of an AI productivity tool such as for chat-enabled environments (voice, text, etc.). Often, these chat-enabled environments are described as AI productivity tool modules that receive this voice or text input from a user and implement a number of actions or responses based on the natural language of the input. In some information handling systems, plural AI productivity tool modules, as provided by one or more independent software vendors (ISVs) or provided by an original equipment manufacturer (OEM) of the information handling system, may interface with computer-readable program code instructions of various AI productivity tool-enablable software applications being executed or executable on the information handling system in embodiments herein. In an embodiment, each of the plural AI productivity tool modules, from the one or more ISVs such as an operating system (OS) provider or the information handling system manufacturer (e.g., the OEM), may have published or designated capabilities which may respond to a user-query input.

These AI productivity tool-enablable software applications may integrate with the plural AI productivity tools to allow user queries to trigger certain actions declared, supported, and managed or conducted by these AI productivity tool-enablable software applications to provide responsive hardware or software operations in services, or a generate responses to the user input query. However, the plurality of AI productivity tool modules may have overlapping AI productivity tool-enablable software application capabilities that may be invoked to respond to a user-query input. This may result in redundancy or inconsistency in response to user-query inputs when the plural AI productivity tools are operating, however, expanded sets of capabilities may increase the responsiveness and abilities of the plural AI productivity tools to use AI productivity tool-enablable software applications for responses to user-query inputs.

During execution of the computer-readable program code instructions of the AI productivity tool subagent associated with the one or more AI productivity tool software modules, capabilities associated with one or more built-in AI productivity tool-enablable software applications accessible by an OEM AI productivity tool while one or more plug-in AI productivity tool-enablable software applications may be accessible by an ISV AI productivity tool. Thus, the available range of capabilities from the plural AI productivity tools may need to be orchestrated such that the user’s intent as reflected in the user-query input can be appropriately executed. Indeed, in some embodiments, the identified capabilities associated with the one or more built-in and plug-in AI productivity tool-enablable software applications from the plural AI productivity tools may have overlapping/conflicting capabilities that cannot be executed concurrently and/or complementary capabilities that could or should be executed concurrently. When plug-in AI productivity tool-enablable software applications are uploaded to the information handling system via an ISV AI productivity tool, the capabilities associated with the new plug-in AI productivity tool-enablable software applications may conflict with capabilities associated with the built-in AI productivity tool-enablable software applications or may be available to complement those built-in AI productivity tool-enablable software applications already operating via an OEM AI productivity tool. Embodiments of the present disclosure execute to control the execution of these capabilities, in terms of priority of capabilities or complementary execution of the same, associated with both the built-in and plug-in AI productivity tool-enablable software applications. The systems and methods described in embodiments herein include a capability discovery software application that identifies each capability associated with each of the built-in AI productivity tool-enablable software applications of an OEM AI productivity tool and plug-in AI productivity tool-enablable software applications of one or more ISV AI productivity tools prior to the AI productivity tool subagent receiving the user-query input. A capability orchestrator software application may then coordinate the execution of capability intent actions based on identified capabilities that can fulfill the user-query input from the user as among the built-in AI productivity tool-enablable software applications and plug-in AI productivity tool-enablable software applications or among plug-in AI productivity tool-enablable software applications of plural ISV AI productivity tools.

The present specification describes a system and method of prioritizing among built-in and plug-in capabilities, or plural sets of plug-in capabilities, executed at the information handling system. The system may include a hardware processing device, a data storage device, and a power management unit (PMU) to provide power to the hardware processing device and data storage device. The hardware processor may execute computer-readable program code instructions of a capability discovery software application to identify capabilities associated with built-in AI productivity tool-enablable software applications and plug-in AI productivity tool-enablable software applications as described in embodiments herein. The hardware processor may also execute computer-readable program code instructions of one or more AI productivity tool software modules, such as from an OEM or one or more ISVs, to receive a user-query input and invoke a plurality of machine learning (ML) model algorithms via an AI productivity tool subagent to identify a plurality of capabilities that could be responsive to that user-query input. In an embodiment, the capabilities may be associated with capabilities of any of the built-in AI productivity tool-enablable software applications of an OEM AI productivity tool and plug-in AI productivity tool-enablable software applications of one or more ISV AI productivity tools that are responsive to the user-query input.

The one or more of the AI productivity tool software modules can execute responsive capability intent actions based on the user-query input received. The hardware processor may further execute computer-readable program code instructions of a capability orchestrator software application to execute a capability ranking LLM algorithm used to rank each of the plurality of identified capabilities from the plural AI productivity tool software modules based on a confidence score generated by the execution of the computer-readable program code of the capability orchestrator software application. With the ranked list of capabilities, hardware processor may execute the computer-readable program code instructions of the capability orchestrator software application to prioritize each of the ranked plurality of capabilities associated with built-in AI productivity tool-enablable software applications from the OEM AI productivity tool and plug-in AI productivity tool-enablable software applications from one or more ISV AI productivity tools. The capability orchestrator software application may prioritize the ranked list of capabilities based on policy metadata associated with each of the plurality of ranked capabilities associated with built-in AI productivity tool-enablable software applications and plug-in AI productivity tool-enablable software applications.

In an embodiment, the hardware processor to execute computer-readable program code instructions of a capability orchestrator software application to determine if the confidence score meets or exceeds a confidence score threshold. In an embodiment, when the confidence score associated with any of the capabilities associated with built-in AI productivity tool-enablable software applications and plug-in AI productivity tool-enablable software applications does not meet or exceed the confidence score threshold, the associated capabilities associated with built-in AI productivity tool-enablable software applications and plug-in AI productivity tool-enablable software applications are not placed within a queue for execution by the AI productivity tool subagent. In another embodiment, when the confidence score associated with any of the capabilities associated with built-in AI productivity tool-enablable software applications and plug-in AI productivity tool-enablable software applications does meet or exceed the confidence score threshold, the associated capabilities associated with built-in AI productivity tool-enablable software applications and plug-in AI productivity tool-enablable software applications are placed within a queue for execution by the AI productivity tool subagent.

In an embodiment, the hardware processor may execute the computer-readable program code instructions of the capability orchestrator software application to access a capability policy database to retrieve policy metadata and associated capabilities associated with each built-in AI productivity tool-enablable software applications and each plug-in AI productivity tool-enablable software applications identified by the capability discovery software application. This policy metadata may be generated prior to execution of any capability intent actions such that the capabilities associated with built-in AI productivity tool-enablable software applications and plug-in AI productivity tool-enablable software applications from the plurality of AI productivity tool modules on the information handling system can be properly ranked. As such, the policy metadata may define which of the capabilities associated with any of the built-in AI productivity tool-enablable software applications and plug-in AI productivity tool-enablable software applications can be executed with each other or not. In an embodiment, the policy metadata describes which other capabilities are allowed or not allowed to be executed when each of the capabilities associated with built-in AI productivity tool-enablable software applications and plug-in AI productivity tool-enablable software applications are executed. In an embodiment, the policy metadata may also describe that each of the capabilities associated with each of the built-in AI productivity tool-enablable software applications from a first of the plurality of AI productivity tool modules on the information handling system do or do not have priority over the capabilities associated with each of the plug-in AI productivity tool-enablable software applications of a second of other AI productivity module or modules.

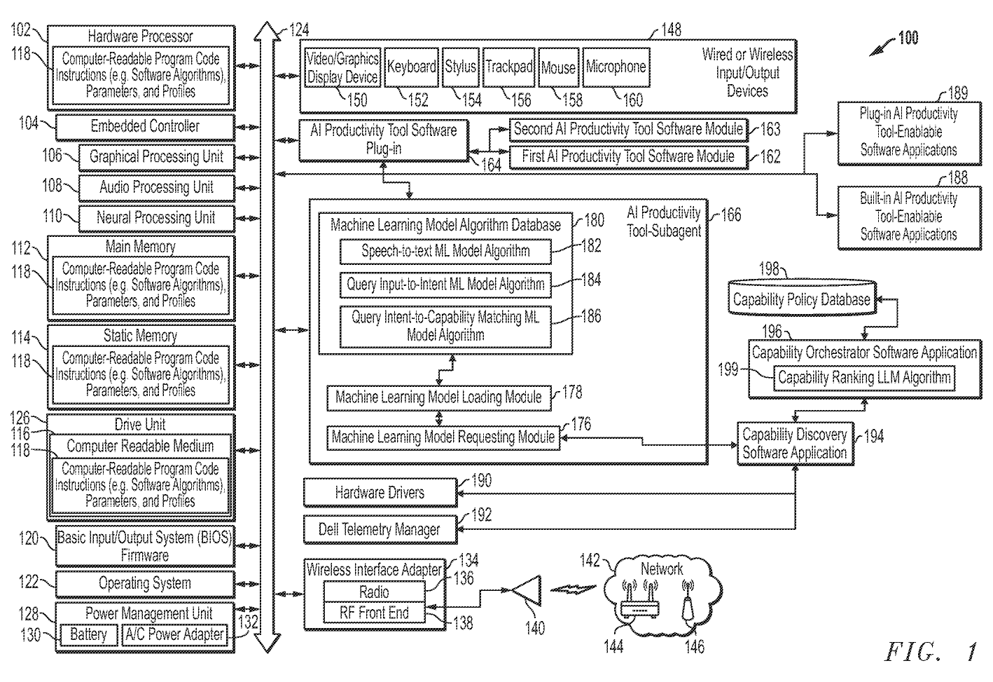

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer-readable code instructions stored in main memory 112 (e.g., RAM) may be accessible by hardware processing resources using that main memory 112. Computer-readable program code instructions stored in static memory 114, main memory 112, or drive unit 126 may be involved in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a video/graphics display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms), parameters, and profiles 118 that may operate on servers or systems, remote data centers, or on-box in individual client information handling systems according to various embodiments herein. In some embodiments, it is understood any or all portions of computer-readable program code instructions (e.g., software algorithms) parameters, and profiles 118 may operate on a plurality of information handling systems 100.

The information handling system 100 may include the hardware processor 102 such as a central processing unit (CPU) or other hardware processing resources (e.g., 104, 106, 108, 110). Any of the hardware processing resources may operate to execute computer-readable code instructions that are either firmware or software code, such as those software systems and modules described herein in execution of orchestrating a plurality of capabilities from plural AI productivity tool software modules 162 or 163. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer-readable medium 116 storing computer-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such a keyboard 152, a mouse 158, video/graphics display device 150, stylus 154, trackpad 156, microphone 160, among other peripheral devices.

As described herein, the information handling system 100 further includes a video/graphics display device 150. The video/graphics display device 150 in an embodiment may function as a liquid crystal display (LCD), an organic light emitting diode (OLED), a flat panel display, or a solid-state display. It is appreciated that the video/graphics display device 150 may be wired or wireless and may be an external video/graphics display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the video/graphics display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among devices such as with Bluetooth® or to a network 142, e.g., a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth ®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 144 or base station 146 used to operatively couple the information handling system 100 to a network 142 via a wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols.

In an embodiment, the wireless interface adapter 134 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit. Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable program code instructions, parameters, and profiles 118 may be transmitted or received over the network 142 via the network interface device or wireless interface adapter 134.

The information handling system 100 may include a set of computer-readable program code instructions, parameters, and profiles 118 that may be executed to cause the computer system to perform any one or more of the methods or computer-based functions disclosed herein. For example, computer-readable program code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application computer-readable program code instructions, parameters, and profiles 118 may be coordinated by an operating system (OS) 122, and/or via an application programming interface (API) include a unified device API described herein. An example OS 122 may include Windows ®, Android ®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain computer-readable medium (not shown), such as RAM in an example embodiment. An example of main memory 112 includes random-access memory (RAM) such as static RAM (SRAM), dynamic RAM (DRAM), non-volatile RAM (NV-RAM), or the like, read-only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, a video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 to provide this power. The PMU 128 may be coupled to the bus 124 to provide or receive data or machine-readable code instructions. The PMU 128 may regulate power from a power source such as the battery 130 or AC power adapter 132. In an embodiment, the battery 130 may be charged via the AC power adapter 132 and provide power to the components of the information handling system 100, via wired connections as applicable, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer-readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described in embodiments herein, the information handling system 100 includes one or more AI productivity tool software modules 162 and 163 and an AI productivity tool software plug-in 166 to receive user-query input and provide that user-query input to the AI productivity tool subagent 166. The first AI productivity tool software module 162 may include an OEM AI productivity tool with a set of capabilities that are executable on the information handling system 100 in embodiments of the present disclosure. A second AI productivity tool software module 163, or group of modules, may include one or more ISV AI productivity tools that have additional sets of capabilities that are executable on the information handling system 100 in embodiments of the present disclosure. In the embodiments herein, the user-query input may include audio input received from, for example, the microphone 160. In another embodiment, the user-query input may include text input by the user by the keyboard 152. In an embodiment, the execution of the computer-readable program code instructions 118 of the AI productivity tool subagent 166 by the hardware processor 102 or any other hardware processing device selects among a plurality of available ML module algorithms 182, 184, 186 maintained within a ML model algorithm database 180 for use with execution of the plurality of AI productivity tool software modules 162 and 163.

These plural AI productivity tool software modules 162 and 163 may invoke one or more sets of capabilities of built-in or plug-in AI productivity tool-enablable software applications 188 or 189 executable on the information handling system 100 according to embodiments of the present disclosure. As described herein, the computer-readable program code instructions 118 of the AI productivity tool software modules 162 or 163 with a single or their own AI productivity tool subagent or subagents 166 as well as available ML module algorithms 182, 184, 186 may be executed by a hardware processor 102 or other ML model algorithm execution provider hardware processing resource on the information handling system 100. The execution of code instructions of the AI productivity tool subagent or subagents 166 as well as available ML module algorithms 182, 184, 186 thereby allow the processes of the plural AI productivity tool software module 162 or 163 to identify responsive capabilities from among their respective sets of capabilities and respond to received user-query inputs according to methods described herein. The execution of the AI productivity tool subagent or subagents 166 as well as available ML module algorithms 182, 184, 186 for the one or more AI productivity tool software modules 162 and 162 may be carried out on-the-box such that a wired or wireless network connection to a network is not necessary for operation of the method. In another embodiment, some modules, databases, and/or processing resources such as ML module algorithms 182, 184, 186 may be maintained on a remote server such that a wired or wireless network connection can be made with these remote servers and the method may be implemented as described herein.

The first and second plural AI productivity software tool modules 162 and 163 may include any artificial intelligence-based productivity tool to assist in interfacing with and execution of one or more built-in or plug-in AI productivity tool-enablable software applications 188 or 189 and receive user-query inputs from a user and generate responses as responsive capability intent actions at an information handling system 100. The first and second plural AI productivity software tool modules 162 and 163 may be loaded on-the-box by an OEM manufacturer or via uploads in software from one or more ISVs, such as an operating system ISV. These first and second plural AI productivity software tool modules 162 and 163 may include chatbot features, virtual assistant features, and other artificial intelligence features that allow a user to provide input to the information handling system 100 and, with generative artificial intelligence processing of the user-query input, execute one or more responsive capabilities from various sets of capabilities that include hardware operations, functions, software services such as by using one or more AI productivity tool-enablable software applications 188 or 189. Examples of some types of first and second plural AI productivity software tool modules 162 and 163 may include Cortana ® by Microsoft ®, Copilot ® by Microsoft ®, Siri ® by Apple ® Inc., Gemini ® by Google AI®, ChatGPT ® by OpenAI ®, and Amazon Alexa ® by Amazon ®, among others. It is appreciated that the information handling system 100 may include any proprietary first AI productivity tool software module 162 that is an OEM AI productivity tool installed by an information handling system 100 manufacturer and used to interface with the information handling system 100 and the operations thereon. In various embodiments, the hardware processor 102 or other alternative hardware processing resources of the information handling system 100 may execute computer-readable program code instructions of first and second plural AI productivity software tool modules 162 and 163 and one or more AI productivity tool plug-ins 164 and monitor for user input for a user query at a microphone 160, keyboard 152, or other input device for the AI productivity tool subagent 166 to engage in determining capability intent actions responsive to the user-query input.

The first and second plural AI productivity software tool modules 162 and 163, executing on the hardware processor 102, such as a CPU, or other hardware processing resource (e.g., EC 104, GPU 106, APU 108, or NPU 110), may interface with other hardware components and with the AI productivity tool-enablable software applications 188 or 189 as well as the one or more ML model algorithms 182, 184, 186 via an AI productivity tool plug-in 166. The AI productivity tool plug-in 164 may be any software or firmware that allows the AI productivity tool subagent 166 to perform processes of the first and second plural AI productivity software tool modules 162 and 163 to determine capability intent actions responsive to a user-query input at the information handling system 100 based on specific types of user-query input (e.g., typed, spoken words, images, etc.) provided from the user, and in embodiments of the present disclosure. The AI productivity tool plug-in 164 may be used by the first and second plural AI productivity software tool modules 162 and 163 and AI productivity tool subagent or subagents 166 to interface with any number of AI productivity tool-enablable software applications 188 or 189 executing or executable on the information handling system 100 according to embodiments herein.

Again, the information handling system 100 also includes the AI productivity tool subagent or subagents 166 associated with the first and second plural AI productivity software tool modules 162 and 163. The AI productivity tool subagent 166 may be any software and/or firmware executable by the hardware processor 102 or other ML model algorithm execution provider hardware processing resources 104, 106, 108, 110 of the information handling system 100 to interface with one or more of the plurality of the AI productivity tool-enablable software applications 188 or 189 to provide AI enabled capabilities within those AI productivity tool-enablable software applications 188 or 189 for responsive hardware, firmware, or software operations, functions, software services, or responses to user input queries. In an embodiment, the computer-readable program code instructions of the AI productivity tool-enablable software applications 188 or 189 may operate wholly “on-box” within the information handling system 100 or be sub-agents on-box for interfacing with remote software systems executing at remote server locations.

In an embodiment, the AI productivity tool subagent 166 may be used to direct the execution of various modules in support of one or more identified productivity tool operations by the built-in or plug-in AI productivity tool-enablable software applications 188 or 189 and first and second plural AI productivity software tool modules 162 and 163 in responding to user-query inputs described herein. Additionally, the AI productivity tool subagent 166 may be provided with access to the BIOS and OS of the information handling system 100. Example of identified productivity tool operations include execution of code instructions of the first and second plural AI productivity software tool modules 162 and 163 to determine user-query intent values, match these with generated capability intents, and to execute code instructions of one of the built-in or plug-in AI productivity tool-enablable software applications 188 or 189 to conduct commensurate capability intent actions pursuant to the user’s query input.

In an embodiment, during operation, the hardware processor 102 or other hardware processing resource (e.g., EC 104, GPU 106, CPU, APU 108, or NPU 110) executes computer-readable program code instructions of the AI productivity tool subagent or subagents 166. The AI productivity tool subagent or subagents 166 may engage with a machine learning model requesting module 176 to have one or more ML model algorithms 182, 184, 186 loaded and executed on the hardware processor in order to, initially, determine the query intent value of a user-query input and to correlate it with a capability intent action to be conducted responsive to the received user-query inputs.

In an embodiment, the execution of the computer-readable program code instructions of the AI productivity tool subagent 166 may call a software development kit (SDK) module. The SDK module may include any computer-readable program code instructions that is executed by the hardware processor 102 or other hardware processing resource to request that a ML model algorithm 182, 184, 186 that may be invoked to support the identification of, in an embodiment, one or more capability intent action based on received user-query inputs from a user at the first and second plural AI productivity software tool modules 162 and 163.

In example embodiments herein, the ML model algorithms 182, 184, 186 may include a query input-to-intent ML model algorithm 184 that receives the user-query input, and with an embedding algorithm generates a vectorized query intent value for the user-query input for later correlation with a capability intent value. In embodiments where the user-query input is in audio form, the AI productivity tool subagent 166 may invoke the execution of a speech-to-text ML model algorithm 182 to initially convert this audio into text for use with the query input-to-intent ML model algorithm 184 to generate the vectorized query intent value for the user-query input for later correlation with a capability intent value as described herein. In an example embodiment, the ML model algorithms 182, 184, 186 may also include a query intent-to-capability matching ML model algorithm 186. The query intent-to-capability matching ML model algorithm 186 receives the vectorized query intent value from the execution of the query input-to-intent ML model algorithm 184 as input and then matches the vectorized query intent value to a vectorized capability intent value associated with the AI productivity tool-enablable software application 188 or 189 via a similarity correlation algorithm for lexical or semantic matching to identify a responsive capability that can serve as the capability intent action responsive to a user-query input.

In embodiments of the present disclosure, the capabilities may include capabilities associated with one or more built-in AI productivity tool-enablable software applications 188 as accessible through a first AI productivity software tool module 162. Example built-in AI productivity tool-enablable software applications 188 may include Dell ® Optimizer®, Dell® SupportAssist®, as well as any other built-in AI productivity tool-enablable software applications 188 that can change features, settings, or other actions on the information handling system associated with, for example, information handling system adjustments or adjustments to built-in peripheral devices. It is appreciated that capabilities associated with these built-in AI productivity tool-enablable software applications 188 may include adjustments to a brightness of the video/graphics display device 150, power adjustments at the PMU 128, adjustment to thermal tables (fan/acoustic/hardware processor throttling), system firmware indicator of attacks (IoAs), firmware vulnerability exposure and recommended migrations via Dell® Trusted Device®.

In embodiments of the present disclosure, the capabilities may include sets of capabilities associated with one or more plug-in AI productivity tool-enablable software applications 189 as accessible through one or more second AI productivity software tool modules 163. Example plug-in AI productivity tool-enablable software applications 189 may include an ISV antivirus software application such as Windows ® Defender ® and McAfee ® antivirus software applications, Norton ® antivirus software applications, Secure Boot ® of the Unified Extensible Firmware Interface (UEFI) specifications, Windows ® Power and Sleep Settings ®, updates of Windows® Defender® antivirus definition files, updating of network firewall settings, and the like. Example plug-in AI productivity tool-enablable software applications 189 may also include Logitech ® options customization software or other peripheral device software applications used to adjust settings associated with one or more peripheral devices, uploaded antivirus software applications, Windows ® operating system settings interface, as well as any other plug-in AI productivity tool-enablable software applications 189.

In an embodiment, a built-in AI productivity tool-enablable software application 188 may include any software application or firmware that is built into the information handling system 100 or otherwise preinstalled on the information handling system 100 by an OEM prior to the user receiving the information handling system. In an embodiment, a plug-in AI productivity tool-enablable software application 189 may include any software application that is uploaded or otherwise installed from a third-party source, such as an ISV or a website download.

It is appreciated that the selected ML model algorithms 182, 184, 186 for a similar or common identified AI productivity-tool operation type may satisfy an interface contract requested by the AI productivity tool subagent 166 such that the query intent value from the user-query inputs may be interpreted and an available capability associated with one of the plurality of AI productivity tool-enablable software applications 188 as the capability intent action can be matched to the user’s query input. The interface contract described herein defines the requirements that selected ML model algorithms 182, 184, 186 are to have in order to be able receive a specific type of input from the AI productivity tool software module 162, the AI productivity tool subagent 166, or any AI productivity tool-enablable software application 188 and to provide a specific type of output to the AI productivity tool subagent 166, the AI productivity tool software module 162, and/or AI productivity tool-enablable software applications 188. In an embodiment, the interface contract is generated by an AI productivity proxy API invoked by the SDK module in order to identify the similar or common productivity-tool operation type ML model algorithms 182, 184, 186 that provides the appropriate output to the AI productivity tool subagent 166.

As described herein, the available capabilities associated with any of the built-in AI productivity tool-enablable software applications 188 for an OEM AI productivity tool and plug-in AI productivity tool-enablable software applications 189 for an ISV AI productivity tool may be discovered via execution of a capability discovery software application 194 by a hardware processor 102. In embodiments herein, the first AI productivity tool 162 as an OEM AI productivity tool and one or more second AI productivity tools 163 as ISV AI productivity tools may operate in tandem or may coordinate operation such as with coordinated access to the AI productivity tool subagent 166 for accessing one or more ML model algorithms.

Execution of the computer-readable program code instructions of the capability discovery software application 194 may also cause a record of which capabilities are associated with which built-in AI productivity tool-enablable software application 188 and plug-in AI productivity tool-enablable software application 189 at a capability policy database 198 for access by the first or second AI productivity tools 162, 163. For example, an OS-based ISV AI productivity tool, such as Windows Copilot ®, may operate as a second AI productivity tool 163 and coordinate with an on-board OEM AI productivity tool as the first AI productivity tool 162 installed by an OEM of the information handling system 100. Each of the OEM AI productivity tool (e.g., 162) and the ISV AI productivity tool (e.g., 163) may have respective sets of capabilities from among built-in AI productivity tool-enablable software applications 188 and plug-in AI productivity tool-enablable software applications 189 that are gathered and stored at a capability policy database 198. In an embodiment, execution of computer-readable code instructions of the capability discovery software application 194 may access any number of hardware drivers 190 and or a Dell® Telemetry manager 192 that can access the data associated with any built-in or plug-in AI productivity tool-enablable software application 188 or 189 to identify these capabilities.

Still further, policy metadata may be associated with each of the identified capabilities within the capability policy database 198. The policy metadata may describe whether other capabilities are also to be executed, as complimentary capabilities, when any of the plurality of built-in or plug-in capabilities associated with built-in AI productivity tool-enablable software applications 188 or plug-in AI productivity tool-enablable software applications 189 are executed. The policy metadata may also describe conditions such that any of the capabilities associated with each of the built-in AI productivity tool-enablable software applications 188 do or do not have priority over the capabilities associated with each of the plug-in AI productivity tool-enablable software applications 189, or vice-versa. In other words, the policy metadata may determine conditions by which a capability of a built-in AI productivity tool-enablable software applications 188 will execute instead of a capability of the plug-in AI productivity tool-enablable software application 189, or vice versa, if both are identified as matching and responsive in an embodiment. In other embodiments, the policy metadata may determine conditions by which a capability of a built-in AI productivity tool-enablable software applications 188 will execute ahead of the capability of the plug-in AI productivity tool-enablable software application 189, or vice versa, in an embodiment.

In an embodiment, the execution of the computer-readable program code instructions of the capability discovery software application 194 may cause the information handling system 100 to communicate with, for example, a server over the network 142 to gain access to any and all policy metadata that is to be associated with each of the capabilities stored in the capability policy database 198. In an embodiment, the policy metadata may be transmitted to the information handling system via a .yaml (Yet Another Markup Language) or .json (JavaScript Object Notation) manifest file in order to transmit this structured data in a way such that both humans and machines can understand. In an embodiment, the policy metadata may be received from a third-party when plug-in AI productivity tool-enablable software applications are uploaded to the information handling system. In another embodiment, the built-in AI productivity tool-enablable software applications may have associated policy metadata which is stored in the capability policy database 198 and used in the methods and systems described herein.

In an embodiment, after the AI productivity tool subagent 166 has executed the one or more ML module algorithms 182, 184, 186 in order to identify a plurality of matching capabilities that are associated with a capability intent action responsive to the user-query input, the hardware processor 102 or other processing device may execute computer-readable program code of a capability orchestrator software application 196. Execution of the computer-readable program code instructions of the capability orchestrator software application 196 causes the capability orchestrator software application 196 to execute a capability ranking LLM algorithm 199. The execution of the capability ranking LLM algorithm 199 causes each of the capabilities identified by the AI productivity tool subagent 166 to be ranked. In an embodiment, each of the plurality of capabilities may be ranked based on a confidence score generated by the execution of the computer-readable program code of the capability orchestrator software application.

In an embodiment, the capability orchestrator software application 196 may calculate a confidence score related to each of the capabilities identified via execution of the ML module algorithms 182, 184, 186 by the AI productivity tool subagent 166. In embodiments herein, this confidence score may relate to the precision of matching any given capability in executing a capability intent action that would respond the user’s user-query input. In an embodiment, the confidence score may be probabilistic-related such that a probability value that the identified capability matches the user-query input and can accomplish a capability intent action that can most directly address the user’s user-query input may be used For example, the result of a semantic similarity matching, a lexical similarity matching, or some weighting or blend of the same for statistical matching correlation between the user-query input and the capability may be used among each capability. In an embodiment, a similarity search (e.g., a lexical or semantic matching correlation that identifies a responsive capability to a user-query input per the query intent-to-capability ML model algorithm 186) may serve as the confidence score with the score being 1-cosine_distance (user_input, known_intent) where the cosine_distance is between 0 and 1 such that the more confident values are close to 0. Thus, a maximum score over all known_intent values is the overall score used to decide the confidence score in some embodiments.

In an embodiment, a confidence score threshold may be set such that a confidence score associated with each of those capabilities identified by the AI productivity tool subagent 166 via execution of the ML module algorithms 182, 184, 186 indicates whether the one or more identified capabilities should be placed within an execution queue. Where any given identified capability has a confidence score at or above the confidence score threshold, that capability is placed within the queue for execution by one or more AI productivity tool-enablable software applications 188 or 189 as described herein. It is appreciated that, in some embodiments, the capabilities that have a capability score at or above the confidence score are ranked from highest to lowest confidence score within the queue for execution by their respective AI productivity tool-enablable software applications 188 or 189.

As described herein, the policy metadata may also define whether any given capability will or will not be executed, or its order in execution, by its respective AI productivity tool-enablable software applications 188 exclusive to other capabilities that may also be placed within the queue in some embodiments herein. For example, a user-query input may include “lower (or increase) my screen brightness” and the responsive capability identified as described herein may include a screen brightness adjustment capability associated with a Windows® AI productivity tool software module that is an ISV plug-in capability of an AI productivity tool-enablable software application 188. In this embodiment, the Windows® AI productivity tool software module may execute this capability exclusive of other capabilities because this process can be handled completely by the Windows® AI productivity tool software module. In some other embodiments, the policy metadata may also define whether any given built-in or plug-in capability can be executed by its respective built-in or plug-in AI productivity tool-enablable software applications 188 or 189 must or should be executed along with other capabilities by their respective AI productivity tool-enablable software applications 188 or 189. For example, a user-query input may include “make my system more secure” and the responsive plug-in capabilities may include antivirus definition files and antimalware definition files updating as well as antivirus/antimalware scanning via, for example, Norton ® antivirus software applications and Secure Boot ® of the Unified Extensible Firmware Interface (UEFI) specifications. In this embodiment, the Norton ® antivirus software applications and Secure Boot ® of the Unified Extensible Firmware Interface (UEFI) specifications may execute their respective capabilities to update antivirus definition files and antimalware definition files updating as well as antivirus/antimalware scanning above and below the OS level.

In yet other embodiments, the policy metadata may also define whether any given capability associated with built-in AI productivity tool-enablable software applications 188 should be prioritized over those capabilities associated with plug-in AI productivity tool-enablable software applications 189. This allows capabilities associated with built-in AI productivity tool-enablable software applications 188 to control the changes in features, settings, or other actions on the information handling system such that the capabilities associated with those original equipment manufactures’ AI productivity tool-enablable software applications 188 can control over other plug-in AI productivity tool-enablable software applications 189 from third-party sources that may not understand or customize those capabilities for operation of the information handling system 100.

The system and methods described herein provide for the ability to prioritize the various capability sets for built-in AI productivity tool-enablable software applications 188 and plug-in AI productivity tool-enablable software applications 189 as coordinated between a first AI productivity tool 162 or a second AI productivity tool 163 executing on an information handling system 100. This allows broadens the available scope of available responsive capabilities while managing for overlapping and/or competing capabilities associated with each of the built-in AI productivity tool-enablable software applications 188 and plug-in AI productivity tool-enablable software applications 189 in embodiment herein. AI productivity tools 162 or 163 invoking capability sets for the built-in AI productivity tool-enablable software applications 188 and plug-in AI productivity tool-enablable software applications 189 are monitored such that these capabilities do not result in a first capability intent action being undone, or done twice, or otherwise interfered with by a second capability intent action thereby increasing the efficiency of the first and second AI productivity tool software modules 162 or 163. Still further, by ranking the individual capabilities and requiring that a confidence score threshold to be met by each identified capability, the AI productivity tool subagent 166 may more effectively and accurately identify a capability associated with either of a built-in AI productivity tool-enablable software application 188 or plug-in AI productivity tool-enablable software application 189 that addresses the user-query input provided by the user of the information handling system 100. Additionally, implementation of policy in metadata may be applied by the capability orchestrator software application 196 of embodiments herein to provide for complimentary execution of capabilities of the built-in AI productivity tool-enablable software applications 188 or plug-in AI productivity tool-enablable software applications 189 to be executed in some circumstances or determining priority among those capabilities or deduplication of capabilities in other circumstances.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

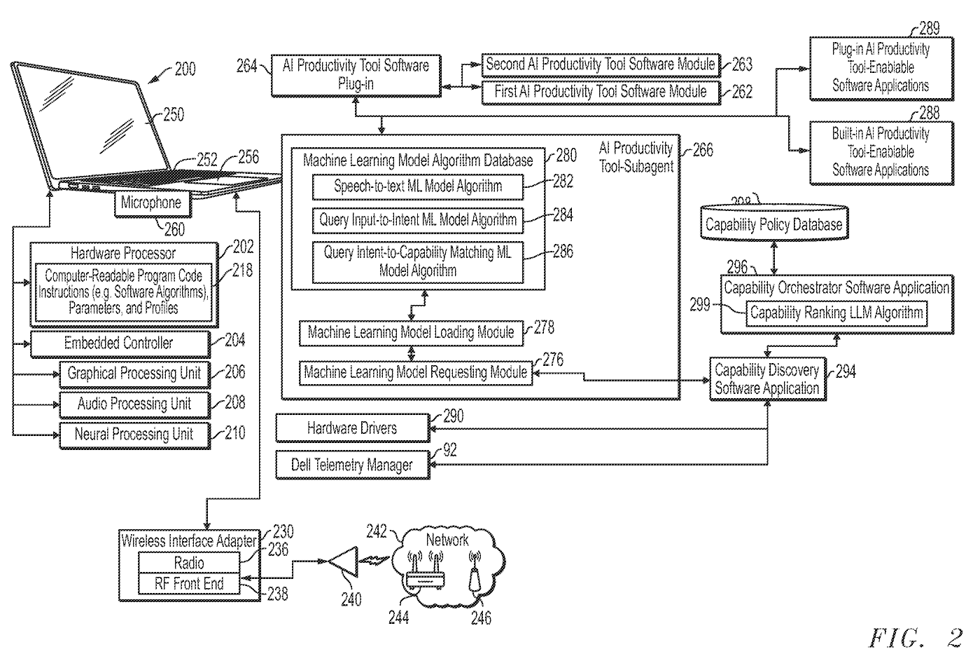

FIG. 2 is a graphic and block diagram illustrating an information handling system that includes one or more AI productivity tool software modules to select among a plurality of built-in or plug-in AI productivity tool-enablable software applications for software services, operations, or responses of those AI productivity tool-enablable software applications according to an embodiment of the present disclosure. As described herein, the information handling system 200 in FIG. 2 is shown as a laptop-type information handling system 200. The information handling system 200 may include a video display device 250 to provide output to the user as well as a keyboard 252, a touchpad 256, and microphone 260 for the user to provide input to the information handling system 200.

As described in embodiments herein, the information handling system 200 includes a first AI productivity tool software module 262, such as an OEM-installed AI productivity tool, and a second or other AI productivity tool software module 263, such as one or more ISV provided AI productivity tools in an embodiment. Further, an AI productivity tool software plug-in 266 may work with the first or second AI productivity tool software modules 262 or 263 to receive user-query input and provide that user-query input to the AI productivity tool subagent 266. In the embodiments herein, the user-query input may include audio input received from, for example, the microphone 260. In another embodiment, the user-query input may include text input by the user by the keyboard 252. In an example embodiment, the user may provide audio input to the information handling system 200 of “make my system secure.” In this example embodiment, this may be responsive to the user concerned about security associated with the operation of the information handing system 200 and wanting to assure that antivirus and/or antimalware software applications available to the information handling system 200 is activated. For purposes of explanation, this user-query input is meant as an example and the present specification contemplates that any other user-query inputs may be presented by the user at the information handling system 200.

In an embodiment, the execution of the computer-readable program code instructions 218 of the AI productivity tool subagent 266 by the hardware processor 202 or any other hardware processing device selects among a plurality of available ML module algorithms 282, 284, 286 maintained within a ML model algorithm database 280 for use with execution of a plurality of AI productivity tool-enablable software applications 288 according to another embodiment of the present disclosure. As described herein, the computer-readable program code instructions 218 of the AI productivity tool software module 262 and AI productivity tool subagent 266 as well as available ML module algorithms 282, 284, 286 may be executed by a hardware processor 202 or other ML model algorithm execution provider hardware processing resource on the information handling system 200 thereby allowing the processes of the AI productivity tool software module 262 to identify capabilities and respond to the received user-query input of “make my system secure” according to methods described herein to be carried out on-the-box such that a wired or wireless network connection to a network is not necessary for operation of the method. In another embodiment, some modules, databases, and/or processing resources such as ML module algorithms 282, 284, 286 may be maintained on a remote server such that a wired or wireless network connection can be made with these remote servers and the method may be implemented as described herein.

The first AI productivity software tool module 262 and second AI productivity tool software module 263 may include any artificial intelligence-based productivity tool to assist in interfacing with and execution of responsive capabilities of one or more built-in AI productivity tool-enablable software applications 288 associated with a first AI productivity tool 262 or capabilities of one or more plug-in AI productivity tool-enablable software applications 289 associated with a second or other AI productivity tool 263 for responding to a received user-query input. For example, the first AI productivity software tool module 262 or second AI productivity tool software module 263 may receive the user-query input of “make my system secure” from a user and generate responses as responsive capability intent actions at an information handling system 200. The first AI productivity tool software module 262 may be loaded on-the-box by a manufacturer and may include interface with a set of capabilities of one or more built-in AI productivity tool-enablable software applications 288. The second or other AI productivity tool software modules 263 may installed with software on-the-box and provided by ISVs to provide interface with a set of capabilities of one or more plug-in AI productivity tool-enablable software applications 289. Overlap of interface with the built-in and plug-in AI productivity tool-enablable software applications 288 or 289 by the first AI productivity software tool module 262 and second AI productivity tool software module 263 is also contemplated in some embodiments.

The first AI productivity software tool module 262 and second AI productivity tool software module 263 may execute in software and may include chatbot features, virtual assistant features, and other artificial intelligence features that allow a user to provide user-query input to the information handling system 200 and, with generative artificial intelligence processing of the user-query input, identify and execute one or more responsive capabilities that include hardware operations, functions, software services such as by using one or more AI productivity tool-enablable software applications 288 or 289. Examples of some types of first or second AI productivity tool software modules 262 or 263 may include Cortana ® by Microsoft ®, Copilot ® by Microsoft ®, Siri ® by Apple ® Inc., Gemini ® by Google AI®, ChatGPT ® by OpenAI ®, and Amazon Alexa ® by Amazon ®, among others. It is appreciated that the information handling system 200 may include any proprietary first AI productivity tool software module 262 installed by an information handling system 200 manufacturer, such as an OEM AI productivity tool, and used to interface with the information handling system 200 and the operations thereon. Further, it is contemplated that coordination may occur between the first AI productivity software tool module 262 and second AI productivity tool software module 263, such as between an OEM AI productivity tool and an OS-software based AI productivity tool executing on an information handling system via an AI productivity tool plug-in 264 with APIs installed on the information handling system 200 to bridge between the first AI productivity software tool module 262 and second AI productivity tool software module 263 in embodiments herein.

In various embodiments, the hardware processor 202 or other alternative hardware processing resources of the information handling system 200 may execute computer-readable program code instructions of the first or second AI productivity tool software modules 262 or 263 with its AI productivity tool plug-in 264 and monitor for user input for a user query such at the user-query input “make my system secure” at a microphone 260, keyboard 252, or other input device for the AI productivity tool subagent 266. In this way, the AI productivity tool subagent 266 engages in determining capability intent actions responsive to the user-query input via capability sets of the built-in AI productivity tool enablable software applications 288 and the plug-in AI productivity tool enablable software applications 289 associated with either or both of the first or second AI productivity tool software modules 262 or 263 in embodiments herein.

The first or second AI productivity tool software modules 262 or 263, executing on the hardware processor 202, such as a CPU, or other hardware processing resource (e.g., EC 204, GPU 206, APU 208, or NPU 210), may interface with other hardware components and with the AI productivity tool-enablable software applications 288 or 289 as well as the one or more ML model algorithms 282, 284, 286 via an AI productivity tool plug-in 266. The AI productivity tool plug-in 264 may be any software or firmware that allows the AI productivity tool subagent 266 to perform processes of the AI productivity tool software modules 262 or 263 to determine capability intent actions responsive to the user-query input of “make my system secure” at the information handling system 200 based on whether the specific type of user-query input was typed, spoken words, images, and the like provided from the user, and in embodiments of the present disclosure. The AI productivity tool plug-in 264 may be used by the AI productivity tool software modules 262 and 263 and AI productivity tool subagent 266 to interface with any number of built-in or plug-in AI productivity tool-enablable software applications 288 or 289 executing or executable on the information handling system 200 according to embodiments herein.

Again, the information handling system 200 also includes the AI productivity tool subagent 266, or plural subagents in some embodiments, associated with the first and second AI productivity tool software modules 262 and 263. The AI productivity tool subagent 266 may be any software and/or firmware executable by the hardware processor 202 or other ML model algorithm execution provider hardware processing resources 204, 206, 208, 210 of the information handling system 200 to interface with one or more of the plurality of the AI productivity tool-enablable software applications 288 or 289 to provide AI enabled capabilities within those AI productivity tool-enablable software applications 288 or 289 for responsive hardware, firmware, or software operations, functions, software services, or responses to user input queries.

Example built-in AI productivity tool-enablable software applications 288, such as associated with an OEM-installed first AI productivity tool 262 may include a remediation (AMDS) software application, Dell ® Optimizer ® software application, Dell ® Trusted Device ® software application, Dell ® Display and Peripheral Manager ® software application, Alienware® Command Center ® (AWCC) software application, Dell ® Support Assist ® software application, or other virtual assistant module. Example plug-in AI productivity tool-enablable software applications 289 may include an ISV antivirus software application such as Windows ® Defender ® and McAfee ® antivirus software applications, Norton ® antivirus software applications, Secure Boot ® of the Unified Extensible Firmware Interface (UEFI) specifications, Windows ® Power and Sleep Settings ®, updates of Windows® Defender® antivirus definition files, updating of network firewall settings, and the like. Example plug-in AI productivity tool-enablable software applications 289 may also include Logitech ® options customization software or other peripheral device software applications used to adjust settings associated with one or more peripheral devices, uploaded antivirus software applications, Windows ® operating system settings interface, as well as any other plug-in AI productivity tool-enablable software applications 289. In an embodiment, the computer-readable program code instructions of the built-in or plug-in AI productivity tool-enablable software applications 288 or 289 may operate wholly “on-box” within the information handling system 200 or be sub-agents on-box for interfacing with remote software systems executing at remote server locations.

In an embodiment, the AI productivity tool subagent 266 may be used to direct the execution of various modules in support of one or more identified productivity tool operations by the first or second AI productivity tool software modules 262 or 263 or the built-in or plug-in AI productivity tool-enablable software applications 288 or 289 in responding to user-query inputs described herein. Additionally, the AI productivity tool subagent 266 may be provided with access to the BIOS and OS of the information handling system 200. Example of identified productivity tool operations include execution of code instructions of the first or second AI productivity tool software modules 262 or 263 to determine user-query intent values, match these with generated capability intents or capabilities, and to execute code instructions of one of the built-in or plug-in AI productivity tool-enablable software applications 288 or 289 to conduct responsive capability intent actions that are responsive to the user’s query input.

In an embodiment, during operation, the hardware processor 202 or other hardware processing resource (e.g., EC 204, GPU 206, CPU, APU 208, or NPU 210) executes computer-readable program code instructions of the AI productivity tool subagent 266. The AI productivity tool subagent 266 may engage with a machine learning model requesting module 276 to have one or more ML model algorithms 282, 284, 286 loaded and executed on the hardware processor in order to, initially, determine the query intent value of a user-query input and to correlate it with a capability intent action to be conducted responsive to the received user-query inputs.

In an embodiment, the execution of the computer-readable program code instructions of the AI productivity tool subagent 266 may call a software development kit (SDK) module. The SDK module may include any computer-readable program code instructions that is executed by the hardware processor 202 or other hardware processing resource to request that a ML model algorithm 282, 284, 286 that may be invoked to support the identification of, in an embodiment, a capability intent action based on received user-query inputs from a user at the first or second AI productivity tool software modules 262 or 263.

In example embodiments herein, the ML model algorithms 282, 284, 286 may include a query input-to-intent ML model algorithm 284 that receives the user-query input of “make my system secure” and, with an embedding algorithm, generates a vectorized query intent value for the user-query input for later correlation with a capability intent value. In embodiments where the user-query input is in audio form, the AI productivity tool subagent 266 may invoke the execution of a speech-to-text ML model algorithm 282 to initially convert this audio of “make my system secure” into text for use with the query input-to-intent ML model algorithm 284 to generate the vectorized query intent value for the user-query input for later correlation with a capability intent value as described herein. In an example embodiment, the ML model algorithms 282, 284, 286 may also include a query intent-to-capability matching ML model algorithm 286. The query intent-to-capability matching ML model algorithm 286 receives the vectorized query intent value from the execution of the query input-to-intent ML model algorithm 284 as input and then matches the vectorized query intent value to a vectorized capability intent value associated with one of the built-in AI productivity tool-enablable software applications 288 or plug-in AI productivity tool-enablable software applications 289 via a similarity correlation algorithm for lexical or semantic matching to identify a responsive capability that can serve as the capability intent action responsive to a user-query input.

It is appreciated that the selected ML model algorithms 282, 284, 286 for a similar or common identified AI productivity-tool operation type may satisfy an interface contract requested by the AI productivity tool subagent 266 such that the query intent value from the user-query inputs may be interpreted and an available capability associated with one of the plurality of AI productivity tool-enablable software applications 288 as the capability intent action can be matched to the user’s query input. The interface contract described herein defines the requirements that selected ML model algorithms 282, 284, 286 are to have in order to be able receive a specific type of input from the first or second AI productivity tool software module 262 or 263, the AI productivity tool subagent 266, or any AI productivity tool-enablable software applications 288 or 289 and to provide a specific type of output to the AI productivity tool subagent 266, the first or second AI productivity tool software module 262 or 263, and/or AI productivity tool-enablable software applications 288 or 289. In an embodiment, the interface contract is generated by an AI productivity proxy API invoked by the SDK module in order to identify the similar or common productivity-tool operation type ML model algorithms 282, 284, 286 that provides the appropriate output to the AI productivity tool subagent 266.

After identifying capabilities associated with one or more built-in or plug-in AI productivity tool-enablable software applications 288 or 289, a hardware processor may execute computer-readable program code instructions of the capability orchestrator software application 296 as described herein. As described herein, all available capabilities may have been previously discovered via execution of the computer-readable program code instructions of the capability discovery software application 294. Execution of the computer-readable program code instructions of the capability discovery software application 294 causes all potential capabilities associated with any of the built-in or plug-in AI productivity tool-enablable software applications 288 or 289 to be discovered and a record of which capabilities are associated with which built-in AI productivity tool-enablable software application 288 and plug-in AI productivity tool-enablable software application 289 at a capability policy database 298.

Additionally, the execution of the computer-readable program code instructions of the capability discovery software application 294 may cause the information handling system to request and receive policy metadata that is associated with any of the identified capabilities of the built-in AI productivity tool-enablable software applications 288 and plug-in AI productivity tool-enablable software applications 289 within the capability policy database 298. The policy metadata may describe whether other capabilities, that operate complimentary to the selected responsive capability, are to be executed when each of the capabilities associated with built-in AI productivity tool-enablable software applications 288 and plug-in AI productivity tool-enablable software applications 289 are executed in response to a user-query input. The policy metadata may also describe conditions that any of the capabilities associated with the built-in AI productivity tool-enablable software applications 188 do or do not have priority over the capabilities associated with the plug-in AI productivity tool-enablable software applications 189, or vice versa. For example, policy metadata may identify when responsive capabilities of the built-in AI productivity tool-enablable software applications 188 should execute instead of responsive capabilities of the plug-in AI productivity tool-enablable software applications 189, or vice versa, in some embodiments. The policy metadata may identify when responsive capabilities of the built-in AI productivity tool-enablable software applications 188 should execute ahead of responsive capabilities of the plug-in AI productivity tool-enablable software applications 189, or vice versa, in other embodiments. These policies assist in orchestration of execution of responsive capabilities that may overlap or be redundant or assist in avoiding conflicting responses by the first or second AI productivity tools 262 or 263 according to embodiments herein.

In an embodiment, the execution of the computer-readable program code instructions of the capability discovery software application 294 may cause the information handling system 200 to communicate with, for example, a server over the network 242 to gain access to any and all policy metadata that is to be associated with each of the sets of capabilities stored in the capability policy database 298. In an embodiment, the policy metadata may be received from a third-party when plug-in AI productivity tool-enablable software applications 289 are uploaded, for example, to the information handling system. In another embodiment, the built-in AI productivity tool-enablable software applications 288 may have associated policy metadata which is stored in the capability policy database 298, or is downloaded with updates, and used in the methods and systems described herein.

In an embodiment, the data related to the capabilities associated with each of the AI productivity tool-enablable software applications 288 or 289 may be used by the AI productivity tool subagent 266 to identify which of the capabilities are responsive to the user’s user-query input of “make my system secure” by matching the vectorized query intent value to a vectorized capability intent value associated with the built-in or plug-in AI productivity tool-enablable software application 288 or 289 via a similarity correlation algorithm for lexical or semantic matching, for example. As described in the example embodiment where the user-query input is “make my system secure” these identified capabilities may include built-in AI productivity tool-enablable software applications 288 and plug-in AI productivity tool-enablable software applications 289 related to virus protection, malware protection, virus deletion, internet security, and other security capabilities associated with any given AI productivity tool-enablable software application 288 or 289 that would make the user’s information handling system 200 more secure. It is appreciated, however, that not all of these capabilities identified as being responsive to the user-query input may be the most effective in securing the user’s information handling system 200.

Consequently, the execution of the computer-readable program code instructions of the capability orchestrator software application 296 may, initially, calculate a confidence score related to each of the capabilities identified via execution of the ML module algorithms 282, 284, 286 by the AI productivity tool subagent 266. This confidence score relates to the precision in identification of any given capability in executing a capability intent action to satisfy the user’s user-query input of, in this example embodiment, “make my system secure.” In an embodiment, the confidence score may be probabilistic-related such that a probability of the statistical matching correlation to the identified capability to execute a capability intent action that can most directly or accurately respond to the user-query input. In an embodiment, a similarity search statistical correlation (e.g., from a lexical or semantic matching to identify a responsive capability for a capability intent action responsive to a user-query input per the query intent-to-capability ML model algorithm 286) between the user-query input and the responsive capability may serve as the confidence score. In a further example embodiment, the confidence score may include 1-cosine_distance (user_input, known_intent) where the cosine_distance is between 0 and 1 representing the statistical correlation such that the more confident values are close to 0. Thus, scores over all known_intent values are the overall scores used to decide the confidence score in some embodiments.

Additionally, in some embodiments herein, the execution of the computer-readable program code instructions of the capability orchestrator software application 296 causes the capability orchestrator software application 296 to execute a capability ranking LLM algorithm 299. The execution of the capability ranking LLM algorithm 299 causes each of the capabilities identified by the AI productivity tool subagent 266 to be ranked. In an embodiment, each of the plurality of capabilities may be ranked based on the confidence score generated by the execution of the computer-readable program code of the capability orchestrator software application. In an embodiment, a confidence score threshold may be set such that a confidence score associated with each of those capabilities identified by the AI productivity tool subagent 266 via execution of the ML module algorithms 282, 284, 286 indicates whether the one or more identified capabilities should be placed within an execution queue. Where any given identified capability has a confidence score at or above the confidence score threshold, that capability is placed within the queue for execution by one or more built-in and/or plug-in AI productivity tool-enablable software applications 288 or 289 as described herein. It is appreciated that, in some embodiments, the capabilities that have a capability score at or above the confidence score are ranked from highest to lowest confidence score within the queue for execution by their respective built-in or plug-in AI productivity tool-enablable software applications 288 or 289.

The execution of the capability orchestrator software application 296 also considers the policy metadata stored on the capability policy database 298 accessible to the capability orchestrator software application 296. As described herein, the policy metadata may define whether any given responsive capability can be executed by its respective built-in or plug-in AI productivity tool-enablable software applications 288 or 289 exclusive to other capabilities, such that conflict is not of concern and that it and other similar capabilities may also be placed within the queue in some embodiments. In other embodiments, the policy metadata may define whether any given responsive capability can be executed by its respective built-in or plug-in AI productivity tool-enablable software applications 288 or 289 exclusive to other capabilities, such that conflict is not of concern and that it and other similar capabilities must be executed along with the identified responsive capabilities that have also been placed within the queue.

In the context of the present example where the user-query input is “make my system secure” and a plurality of capabilities have been identified via execution of the computer-readable program code instructions of the AI productivity tool subagent 266, the policy metadata may indicate that a plug-in AI productivity tool-enablable software application 288 such as Window® Defender ® may indicate that those capabilities of identifying antiviruses (e.g., via definition files), engaging network firewalls, altering internet browsing settings, and the like can, should, or must be executed along with other built-in AI productivity tool-enablable software applications 288 such as updates to on-board firewalls or basic input/output system (BIOS) security. An example of a built-in AI productivity tool-enablable software application 288 may be Dell® Trusted Device ® software application that may have associated capabilities to scan for indicators of attack (IoA) below the operating system (e.g., 122, FIG. 1) as well as capabilities associated with fixing BIOS, such as security, (e.g., 120, FIG. 1) and other firmware vulnerabilities. Thus, the policy metadata, in this example embodiment, has indicated that both of these built-in AI productivity tool-enablable software applications 288 and plug-in AI productivity tool-enablable software applications 289 must be operated together so that the user’s information handling system 200 is made secure per the user-query input of “make my system secure.” This may be because the policy metadata has indicated that Window® Defender ® application may have access to only those features and settings configurable by the user at or above the OS level while the Dell® Trusted Device ® software application is granted privileges below the OS level, such as a platform BIOS level, that can further alter those settings and firmware that would otherwise not be available for the user to configure or, at least, not configurable via execution of the Window® Defender ® software application alone.

It is appreciated that the policy metadata may also include data describing that other capabilities of built-in and/or plug-in AI productivity tool-enablable software applications 288 or 289 cannot or must not be executed alongside the execution of the Window® Defender ® software application and Dell® Trusted Device ® software application as described in this example embodiment. This means that the Dell® Trusted Device ® software application and Window® Defender ® software application are to be executed separate and apart or not both executed with capabilities of other built-in and/or plug-in AI productivity tool-enablable software applications 288 or 289. Thus, although capabilities associated with abilities that can “make [the user’s] system secure” may have been placed within the queue, the execution of the computer-readable program code instructions of the capability orchestrator software application 296 will remove these other capabilities of built-in and/or plug-in AI productivity tool-enablable software applications 288 or 289 from the queue of capabilities and their associated AI productivity tool-enablable software applications 288 or 289 to be executed. Through this filtering process of identifying responsive capabilities with the AI productivity tool subagent 266, scoring those capabilities with a confidence score via the capability orchestrator software application 296, filtering out those scored capabilities that do not meet or exceed the confidence score threshold, and eliminating those capabilities associated with any number of built-in and/or plug-in AI productivity tool-enablable software applications 288 or 289 based on the policy metadata, the systems and methods described herein may customize the changes in features, settings, or other actions on the information handling system such that the capabilities operate more efficiently. This may provide for improved responses with complimentary execution of capabilities, or reduce conflicting or redundant responses to user-query inputs from the first or second AI productivity tools 262 and 263 in embodiments herein.

In one embodiment, some capabilities may include policy metadata that indicates that capabilities for every built-in AI productivity tool-enablable software application 288 are to take priority, by weighting the ranking or other measures, over capabilities for every plug-in AI productivity tool-enablable software application 289. This prioritization may include a ranking of those capabilities associated with each built-in AI productivity tool-enablable software application 288, such as with a weighting factor, higher within the queue that those capabilities associated with plug-in AI productivity tool-enablable software applications 289 when selecting one or more responsive capabilities in some embodiments. This prioritization may also include placing the each or any particular capabilities associated with built-in AI productivity tool-enablable software application 288 within the execution queue while eliminating each or any particular capabilities associated with plug-in AI productivity tool-enablable software applications 289 from within the queue when the capabilities associated with built-in AI productivity tool-enablable software application 288 are available in other embodiments. For example, this may be done because any or a particular of those capabilities associated with the plug-in AI productivity tool-enablable software applications 289 may be overlapping or redundant with the corresponding capabilities associated with the built-in AI productivity tool-enablable software applications 288 identified as responsive. In yet other embodiments, the one or more capabilities of the plug-in AI productivity tool-enablable software applications 288 may be prioritized over the built-in AI productivity tool-enablable software applications 288.

Having filtered through the available capabilities as described herein, the system and methods allow for the most appropriate responsive capabilities associated with the most appropriate built-in AI productivity tool-enablable software applications 288 and/or plug-in AI productivity tool-enablable software applications 289 to be executed resulting in capability intent actions that best address and respond to the user’s user-query input of, in this example embodiment, “make my system secure.” The system and methods described in embodiments herein provide for the ability of a capability orchestrator software application 296 to prioritize the various built-in AI productivity tool-enablable software applications 288 and plug-in AI productivity tool-enablable software applications 289 to avoid conflicting or duplicated responses from a first AI productivity tool 262 and a second or other AI productivity tools 263. This allows for overlapping and/or competing capabilities associated with each of the built-in AI productivity tool-enablable software applications 288 and plug-in AI productivity tool-enablable software applications 289 to be monitored such that these capabilities do not result in a first capability intent action being conflicted or redundantly performed by a second capability intent action thereby increasing the efficiency of the first and second AI productivity tool software modules 262 and 263. Additionally, the capability orchestrator software application 296 may operate to identify complimentary capabilities associated with each of the built-in AI productivity tool-enablable software applications 288 and plug-in AI productivity tool-enablable software applications 289 to be monitored such that plural complimentary capabilities from either of the built-in AI productivity tool-enablable software applications 288 or plug-in AI productivity tool-enablable software applications 289 may be smoothly executed in coordination by the first and second AI productivity tools 262 and 263 in other embodiments. Still further, by ranking the individual capabilities and requiring that a confidence score threshold to be met by each identified capability, the AI productivity tool subagent 266 may more effectively and accurately identify a capability associated with either of a built-in AI productivity tool-enablable software application 288 or plug-in AI productivity tool-enablable software application 289 that addresses the user-query input provided by the user of the information handling system 200.

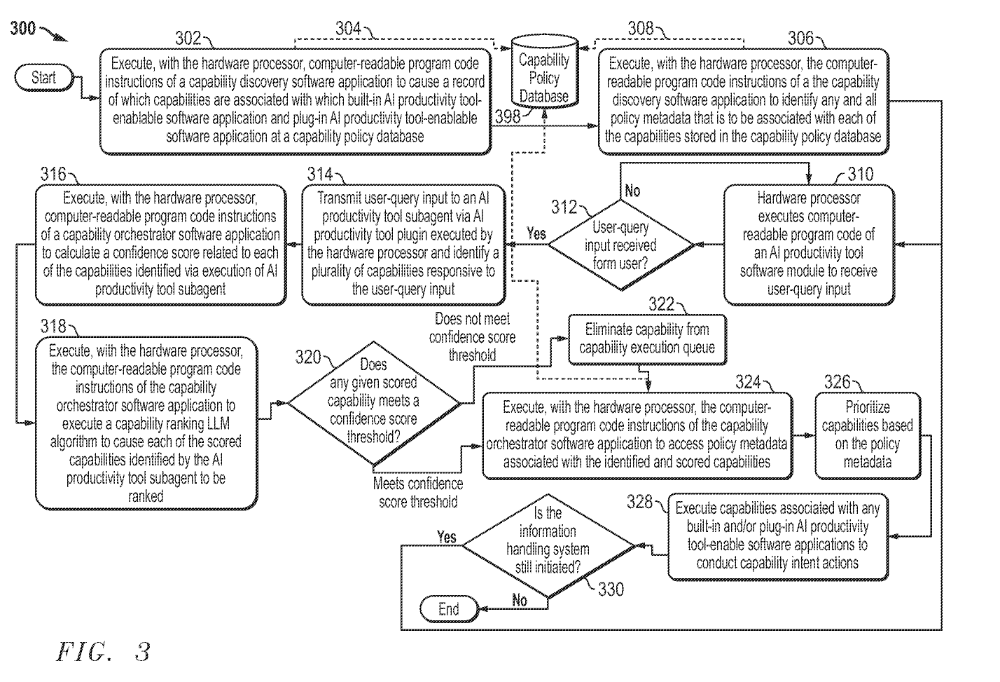

FIG. 3 is a flow diagram showing a method of prioritizing among built-in and plug-in capabilities associated with a plurality of AI productivity tool-enablable software applications to execute capability intent actions pursuant to user-query input according to an embodiment of the present disclosure. The method 300 described in connection with FIG. 3 may be operated on an information handling system such as an information handling system (e.g., 100, 200) described in connection with FIGS. 1 or 2. In an embodiment, the systems and methods described herein may operate on the information handling system such that the method is executed “on-the-box” such that a wired or wireless network connection to a network is not necessary for operation of the method. In another embodiment, some modules, databases, and/or processing resources may be maintained on a remote server and a wired or wireless network connection can be made with these remote servers and the method may be implemented as described herein.

The method 300 may include, at block 302, executing computer-readable program code instructions of a capability discovery software application with a hardware processor to cause a record in a capability policy database 398 of which capabilities are associated with which built-in AI productivity tool-enablable software application and which plug-in AI productivity tool-enablable software application from a plurality of available capabilities at an information handling system. As described herein, the information handling system may include both built-in AI productivity tool-enablable software applications associated with a first AI productivity tool such as an OEM installed AI productivity tool and plug-in AI productivity tool-enablable software applications associated with a second or other AI productivity tool such as an ISV AI productivity tool that have associated capabilities that can control the changes in features, settings, or other actions on the information handling system. In an embodiment, the capability discovery software application may access any number of hardware drivers and or a Dell® Telemetry manager that can access the data associated with any built-in and plug-in AI productivity tool-enablable software applications executable on the information handling system to identify these capabilities. This data is transmitted to the capability policy database 398 at line 304.

Proceeding to block 306, the method 300 includes executing, with the hardware processor, the computer-readable program code instructions of the capability discovery software application to identify any and all policy metadata that is to be associated with each of the capabilities stored in the capability policy database 398. As described herein, the execution of the computer-readable program code instructions of the capability discovery software application may cause the information handling system to communicate with, for example, a server over the network to gain access to any and all policy metadata that is to be associated with each of the capabilities stored in the capability policy database 398. In an embodiment, the policy metadata may be transmitted to the information handling system via a .yaml or .json manifest file in order to transmit this structured data in a way such that both humans and machines can understand. In an embodiment, the policy metadata may be received from a third-party ISV when plug-in AI productivity tool-enablable software applications are uploaded to the information handling system from such independent software vendors. In another embodiment, the built-in AI productivity tool-enablable software applications may have associated policy metadata, which is stored at line 308 by a manufacturer of the information handling system or from download updates in the capability policy database 398 and used in the methods and systems described herein. It is appreciated that the methods described in blocks 302 and 306 as well as lines 304 and 308 may be repeated by the capability discovery software application when additional plug-in AI productivity tool-enablable software applications are uploaded to the information handling system or when any AI productivity tool-enablable software applications (built-in or plug-in) have been modified to support additional capabilities.

The method 300 may include, at block 310, the hardware processor or other hardware processing device of the information handling system executing computer-readable program code instructions of one or more AI productivity tool software modules to receive user-query input. In an embodiment, first AI productivity tool software module may be an OEM installed AI productivity tool on the information handling system. In an embodiment, a second or other AI productivity tool software modules may be an ISV installed AI productivity tool, such as one installed with an OS software, on the information handling system. In an embodiment, first, second, or other AI productivity tool software modules may be any application that can receive input from a user such as text input via the keyboard, image or touch input via a touchpad, or speech input via the microphone, for example. In some embodiments, text or audio may be received by an interface of the one or more AI productivity tool-enablable software modules and the interface managed by the AI productivity tool sub-agent. In an embodiment, the plural AI productivity tool software modules may include a virtual assistant-type AI software agents and those plural first, second or other AI productivity tool software modules operate in coordination with one another via execution of code instructions of an AI productivity tool software plug-in to bridge the various AI productivity tools that may be on the information handling system. The AI productivity tool software plug-in may include one or more application programming interfaces (APIs) to provide for bridging between the first, second or other AI productivity tool software modules. In various embodiments, the hardware processor or other alternative hardware processing resources of the information handling system may execute computer-readable program code instructions of the one or more AI productivity tool software modules with its AI productivity tool software plug-in and monitor for user-query inputs at a microphone, keyboard, or other input device for the AI productivity tool subagent to engage in capability intent actions responsive to the user-query inputs.

Therefore, at block 312, the method 300 includes determining whether any user-query input has been received at the AI productivity tool software module. Where, at block 312, no user-query input is received, the method 300 returns to block 310 with the one or more AI productivity tool software modules continuing to monitor for this input. Where, at block 312, the one or more AI productivity tool software modules do detect and receive user-query input, the method 300 continues to block 314 with the user-query input being transmitted to an AI productivity tool subagent, via an AI productivity tool plug-in being executed by the hardware processor of the information handling system.

In an embodiment, at block 314 the AI productivity tool subagent may provide AI productivity services as described herein. In the embodiments herein, the user-query input may include audio input received from, for example, the microphone. In another embodiment, the user-query input may include text input by the user by the keyboard. In an embodiment, the execution of the computer-readable program code instructions of the AI productivity tool subagent by the hardware processor or any other hardware processing device selects among a plurality of available ML module algorithms maintained within a ML model algorithm database for use with execution of a plurality of built-in or plug-in AI productivity tool-enablable software applications according to another embodiment of the present disclosure. As described herein, the computer-readable program code instructions of the one or more AI productivity tool software modules, including one that is OEM installed and one or more ISV installed, and AI productivity tool subagent as well as available ML module algorithms may be executed by a hardware processor or other ML model algorithm execution provider hardware processing resource on the information handling system. The AI productivity tool subagent and ML module algorithms thereby allow the processes of any of the OEM or ISV AI productivity tool software modules to identify capabilities and respond to received user-query inputs according to methods described herein to be carried out on-the-box such that a wired or wireless network connection to a network is not necessary for operation of the method. In another embodiment, some modules, databases, and/or processing resources such as ML module algorithms may be maintained on a remote server such that a wired or wireless network connection can be made with these remote servers and the method may be implemented as described herein.

The AI productivity tool subagent may engage with a machine learning model requesting module to have one or more ML model algorithms loaded and executed on the hardware processor in order to, initially, determine the query intent value of a user-query input and to correlate it with a capability intent action to be conducted responsive to the received user-query inputs. In an embodiment, the execution of the computer-readable program code instructions of the AI productivity tool subagent may call an SDK module. The SDK module may include any computer-readable program code instructions that is executed by the hardware processor or other hardware processing resource to request that a ML model algorithm that may be invoked to support the identification of, in an embodiment, a capability intent action based on received user-query inputs from a user at an any of the one or more AI productivity tool software modules.

In example embodiments herein, the ML model algorithms may include a query input-to-intent ML model algorithm that receives the user-query input, and with an embedding algorithm generates a vectorized query intent value for the user-query input for later correlation with a capability intent value. In embodiments where the user-query input is in audio form, the AI productivity tool subagent may invoke the execution of a speech-to-text ML model algorithm to initially convert this audio into text for use with the query input-to-intent ML model algorithm to generate the vectorized query intent value for the user-query input for later correlation with a capability intent value as described herein. In an example embodiment, the ML model algorithms may also include a query intent-to-capability matching ML model algorithm. The query intent-to-capability matching ML model algorithm receives the vectorized query intent value from the execution of the query input-to-intent ML model algorithm as input and then matches the vectorized query intent value to a vectorized capability intent value associated with the AI productivity tool-enablable software application via a similarity correlation algorithm for lexical or semantic matching to identify a responsive capability that can serve as the capability intent action responsive to a user-query input. In embodiments of the present disclosure, the capabilities may include capabilities associated with one or more built-in AI productivity tool-enablable software applications.

Example built-in AI productivity tool-enablable software applications, such as associated with an OEM-installed first AI productivity tool may include a remediation (AMDS) software application, Dell ® Optimizer ® software application, Dell ® Trusted Device ® software application, Dell ® Display and Peripheral Manager ® software application, Alienware® Command Center ® (AWCC) software application, Dell ® Support Assist ® software application, or other virtual assistant module. Example plug-in AI productivity tool-enablable software applications may include an ISV antivirus software application such as Windows ® Defender ® and McAfee ® antivirus software applications, Norton ® antivirus software applications, Secure Boot ® of the Unified Extensible Firmware Interface (UEFI) specifications, Windows ® Power and Sleep Settings ®, updates of Windows® Defender® antivirus definition files, updating of network firewall settings, and the like. Example plug-in AI productivity tool-enablable software applications may also include Logitech ® options customization software or other peripheral device software applications used to adjust settings associated with one or more peripheral devices, uploaded antivirus software applications, Windows ® operating system settings interface, as well as any other plug-in AI productivity tool-enablable software applications. In an embodiment, a built-in AI productivity tool-enablable software application may include any software application or firmware that is built into the information handling system or otherwise preinstalled on the information handling system by an OEM prior to the user receiving the information handling system. In an embodiment, a plug-in AI productivity tool-enablable software application may include any software application that is uploaded or otherwise installed from a third-party source such as an OS or other software vendor.

It is appreciated that the selected ML model algorithms for a similar or common identified AI productivity-tool operation type may satisfy an interface contract requested by the AI productivity tool subagent such that the query intent value from the user-query inputs may be interpreted and an available capability associated with one of the plurality of AI productivity tool-enablable software applications as the capability intent action can be matched to the user’s query input. The interface contract described herein defines the requirements that selected ML model algorithms are to have in order to be able to receive a specific type of input from the one or more AI productivity tool software modules, the AI productivity tool subagent, or any built-in or plug-in AI productivity tool-enablable software application and to provide a specific type of output to the AI productivity tool subagent, the one or more AI productivity tool software modules, and/or AI productivity tool-enablable software applications. In an embodiment, the interface contract is generated by an AI productivity proxy API invoked by the SDK module in order to identify the similar or common productivity-tool operation type ML model algorithms that provides the appropriate output to the AI productivity tool subagent.

At block 316, the method 300 includes executing computer-readable program code instructions of a capability orchestrator software application to calculate a confidence score related to each of the capabilities identified via execution of AI productivity tool subagent. Each of these capabilities includes those capabilities identified via execution of the ML module algorithms by the AI productivity tool subagent as described in block 314. The confidence score relates to the precision in any given capability in executing a capability intent action that would satisfy the user’s user-query input, whether from built-in AI productivity tool-enablable software applications or plug-in AI productivity tool-enablable software applications from the plural AI productivity tool software modules. In an embodiment, the confidence score may be probabilistic-related such that a probability that the identified capability matches user-query input such that statistically correlation indicates its capability intent action directly address the user’s user-query input. In an embodiment, a similarity search statistical correlation, for example from a lexical or semantic matching to identify a responsive capability that can serve as the capability intent action responsive to a user-query input per the query intent-to-capability ML model algorithm, may serve as the confidence score. In one example embodiment, the confidence score may be 1-cosine_distance(user_input, known_intent) where the cosine_distance is between 0 and 1 representing statistical correlation between a user-query input and capability such that the more confident values are close to 0. Thus, a scores over all known_intent values are used as confidence scores used to decide the rankings of capabilities from built-in AI productivity tool-enablable software applications or plug-in AI productivity tool-enablable software applications from the plural AI productivity tool software modules in some embodiments.

The method 300 further includes, at block 318, executing computer-readable program code instructions of a capability orchestrator software application with the hardware processor to execute a capability ranking LLM algorithm to cause each of the scored capabilities identified by the AI productivity tool subagent to be ranked. The execution of the capability ranking LLM algorithm causes each of the capabilities identified by the AI productivity tool subagent to be ranked. In an embodiment, each of the plurality of capabilities may be ranked based on a confidence score generated by the execution of the computer-readable program code of the capability orchestrator software application.

At block 320, the method 300 continues with executing computer-readable program code instructions of a capability orchestrator software application to determine if any given scored capability of the built-in AI productivity tool-enablable software applications or plug-in AI productivity tool-enablable software applications from the plural AI productivity tool software modules meets a confidence score threshold. In an embodiment, a confidence score threshold may be set such that a confidence score associated with each of those capabilities identified by the AI productivity tool subagent via execution of the ML module algorithms indicates whether the one or more identified capabilities should be placed within a capability execution queue. Where any given identified capability has a confidence score at or above the confidence score threshold, that capability is placed within the queue for execution by one or more AI productivity tool-enablable software applications as described herein. It is appreciated that, in some embodiments, the capabilities that have a capability score at or above the confidence score are ranked from highest to lowest confidence score within the queue for execution by their respective AI productivity tool-enablable software applications. Where, at block 320 a scored capability does not, at least, meet the confidence score threshold, the method 322 continues to block 322 with that scored capability being eliminated from the capability execution queue. Having removed those unqualifying scored capabilities, the method continues to block 324 as described herein.

Where, at block 320, the scored capabilities do meet or exceed the confidence score threshold, the method 300 continues to block 324. At block 324, the method 300 includes executing the computer-readable program code instructions of the capability orchestrator software application with a hardware processor to access policy metadata associated with the identified and scored capabilities. As described herein, this policy metadata is stored on the capability policy database and is made accessible to the capability orchestrator software application for use in determining the prioritization of the identified and scored capabilities from the built-in AI productivity tool-enablable software applications or plug-in AI productivity tool-enablable software applications. As described herein, the policy metadata may also define whether any given capability can be executed by its respective built-in AI productivity tool-enablable software applications or plug-in AI productivity tool-enablable software applications from the plural AI productivity tool software modules such that other complimentary capabilities that may also be placed within the queue where policy metadata of a capability requires or recommends such addition execution in some embodiments herein.

In some other embodiments, the policy metadata may also define whether any given ranked capability to be executed by a built-in or plug-in respective AI productivity tool-enablable software applications must not or should not be executed with other capabilities. For example, a capability of the built-in AI productivity tool-enablable software applications may be categorized, such as by similar capability intent values, with another capability of a plug-in AI productivity tool-enablable software applications from the plural AI productivity tool software modules. In such an embodiment, execution of the responsive capability of the built-in AI productivity tool-enablable software applications may be redundant to or conflicting with execution of the similarly categorized capability of the plug-in AI productivity tool-enablable software applications. In an example embodiment, similarly categorized capabilities may be determined from both capabilities have capability intent values within a statistical correlation threshold of one another indicating close semantic similarity or determined from capability identification codes for the type of capabilities. In such as case a policy metadata may forbid execution of both capabilities from the plural built-in and plug-in AI productivity tool-enablable software applications.

In yet other embodiments, the policy metadata may also define whether any given capability associated with built-in AI productivity tool-enablable software applications should be prioritized over those capabilities associated with plug-in AI productivity tool-enablable software applications, or vice versa. In one example, the policy metadata may set forth whether any given capability associated with built-in AI productivity tool-enablable software applications should be prioritized over similarly categorized capabilities associated with plug-in AI productivity tool-enablable software applications, or vice versa. In other embodiments, the similarity categorization may not be required and the policy metadata may define specific or particular capabilities of built-in AI productivity tool-enablable software applications should be prioritized over particular capabilities associated with plug-in AI productivity tool-enablable software applications, or vice versa, based on that defined policy metadata. In one example embodiment, a policy metadata, determined for example by a manufacturer or information technology decision maker, allows capabilities associated with built-in AI productivity tool-enablable software applications to control the changes in features, settings, or other actions on the information handling system in priority, for example, over other ISV loaded plug-in AI productivity tool-enablable software applications. In such an example embodiments, the capabilities associated with those original equipment manufactures’ AI productivity tool-enablable software applications can control, over other plug-in AI productivity tool-enablable software applications and other AI productivity tools from third-party sources that may not understand or customize those capabilities specific to operation of the information handling system.

Thus, at block 326, the method 300 further includes prioritizing the identified and scored capabilities based on the policy metadata. For example, some capabilities may include policy metadata that indicates that capabilities of every built-in AI productivity tool-enablable software application are to take priority over capabilities of every plug-in AI productivity tool-enablable software application when a responsive capability from a built-in AI productivity tool-enablable software application is available. In other embodiments, some capabilities may include policy metadata that indicates that capabilities of particular built-in AI productivity tool-enablable software applications are to take priority over capabilities of particular plug-in AI productivity tool-enablable software applications when the responsive capability from the built-in AI productivity tool-enablable software application is available. In other embodiments, policy metadata may prioritize capabilities of plug-in AI productivity tool-enablable software applications over built-in AI productivity tool-enablable software applications.

In an example embodiment where some capabilities may include policy metadata that indicates that particular capabilities of built-in AI productivity tool-enablable software applications are to take priority over particular capabilities of plug-in AI productivity tool-enablable software applications when a responsive capability from a built-in AI productivity tool-enablable software application is available, this prioritization may include ranking those capabilities associated with each built-in AI productivity tool-enablable software application higher within the capability execution queue than those capabilities associated with plug-in AI productivity tool-enablable software applications in some embodiments. This prioritization may also include placing the capabilities associated with each built-in AI productivity tool-enablable software application within the queue while eliminating all capabilities associated with plug-in AI productivity tool-enablable software applications from within the queue in an embodiment. This prioritization may also include placing the capabilities associated with each built-in AI productivity tool-enablable software application within the queue while eliminating all capabilities of a similar categorization associated with plug-in AI productivity tool-enablable software applications from within the queue in another embodiment. This may be because those capabilities associated with the plug-in AI productivity tool-enablable software applications may be overlapping or redundant with the capabilities associated with the built-in AI productivity tool-enablable software applications identified.

In another embodiment, this prioritization may also include weighting the confidence score or rankings the capabilities associated with the built-in AI productivity tool-enablable software applications within the queue while not weighting or reducing the weighting of capabilities associated with plug-in AI productivity tool-enablable software applications from within the queue in an embodiment. In the latter embodiment, a strongly correlated capability of a plug-in AI productivity tool-enablable software application may still prevail over a capability of a built-in AI productivity tool-enablable software application with a weaker confidence score in selection from an execution queue. In yet other embodiments, such a weighting of confidence score or rankings may be dependent on similarity categorization between capabilities of both the built-in AI productivity tool-enablable software application relative to the plug-in AI productivity tool-enablable software applications from within the ranked list of the execution queue. It is further appreciated that in some embodiments similar to those prioritizations described above, particular capabilities associated with plug-in AI productivity tool-enablable software applications may be selectively prioritized over particular capabilities of the built-in AI productivity tool-enablable software applications instead according to policy metadata associated with capabilities available.

It is also appreciated that some built-in and/or plug-in AI productivity tool-enablable software applications may require that other built-in and/or plug-in AI productivity tool-enablable software applications are to be executed with each other according to policy metadata. An example embodiment includes the Dell® Trusted Device ® software application and Window® Defender ® antivirus capabilities presented in FIG. 2 which conduct antivirus and antimalware capabilities below and above, respectively, the operating system level. This allows these AI productivity tool-enablable software applications to cooperate with each other to more effectively “make [the user’s] system secure” as referenced in the user-query input presented in FIG. 2.

At block 328, the method 300 also includes executing those identified and scored capabilities associated with any built-in and/or plug-in AI productivity tool-enable software applications to conduct capability intent actions. These actions may control the changes in features, settings, or other actions on the information handling system that are directly responsive to the user-query input as described herein. Having filtered through the available capabilities as described herein, the system and methods allow for the most appropriate capabilities associated with the most appropriate built-in AI productivity tool-enablable software applications and/or plug-in AI productivity tool-enablable software applications to be executed resulting in capability intent actions that best address the user’s user-query input of, in an example embodiment, “make my system secure.” The system and methods described herein provide for the ability to prioritize the various built-in AI productivity tool-enablable software applications and plug-in AI productivity tool-enablable software applications to avoid conflict of resulting capability intent actions or to cause complimentary capability intent actions to be performed. This allows for overlapping and/or competing capabilities associated with each of the built-in AI productivity tool-enablable software applications and plug-in AI productivity tool-enablable software applications to be monitored and managed. The execution of code instructions of the capability orchestrator software application manages these capabilities for each of the built-in AI productivity tool-enablable software applications and plug-in AI productivity tool-enablable software applications from the plural AI productivity tool software modules to avoid any first capability intent action being undone or redone by a second capability intent action when such would create conflicting responses in an embodiment. In other embodiments, execution of code instructions of the capability orchestrator software application manages these capabilities for each of the built-in AI productivity tool-enablable software applications and plug-in AI productivity tool-enablable software applications from the plural AI productivity tool software modules to cause complimentary capability intent actions to be conducted, where required by policy, thereby increasing the efficiency of the plural AI productivity tool software modules. Still further, by ranking the individual capabilities and requiring that a confidence score threshold to be met by each identified capability, the AI productivity tool subagent may more effectively and accurately identify a capability associated with either of a built-in AI productivity tool-enablable software application or plug-in AI productivity tool-enablable software application that addresses the user-query input provided by the user of the information handling system.

At block 330, the method 300 includes determining if the information handling system is still initiated. Where the information handling system is still initiated, the method 300 proceeds to block 310 as described herein. Where the information handling system is no longer initiated, the method 300 may end here.

The blocks of the flow diagrams of FIG. 3 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system to prioritize between selection of responsive built-in and plug-in capabilities executed at the information handling system comprising:
a hardware processing device, a data storage device, and a power management unit (PMU) to provide power to the hardware processing device and data storage device;
the hardware processor to execute computer-readable program code instructions of a capability discovery software application to identify a first set of capabilities associated with built-in AI productivity tool-enablable software applications and a second set of capabilities associated with plug-in AI productivity tool-enablable software applications;
the hardware processor to execute computer-readable program code instructions of an artificial intelligence (AI) productivity tool software module to receive a user-query input and invoke a plurality of machine learning (ML) model algorithms to identify a plurality of responsive capabilities associated with the built-in AI productivity tool-enablable software applications and the plug-in AI productivity tool-enablable software applications that semantically or lexically match as responsive to the user-query input;
the hardware processor to execute computer-readable program code instructions of a capability orchestrator software application determine policy metadata associated with at least one the plurality of responsive capabilities, and ranking each of the plurality of responsive capabilities based on a confidence score generated by the capability orchestrator software application from the matching of the responsive capabilities to the user query input and on policy metadata for those responsive capabilities weighted by the policy metadata identifying requirements of execution for the at least one the plurality of responsive capabilities; and
the hardware processor to execute the computer-readable program code instructions of the capability orchestrator software application to prioritize execution of each of the ranked plurality of responsive capabilities associated with built-in AI productivity tool-enablable software applications and plug-in AI productivity tool-enablable software applications as capability intent actions responsive to the user query input received.

2. The information handling system of claim 1 further comprising:
the hardware processor to execute computer-readable program code instructions of the capability orchestrator software application to determine if the confidence score meets or exceeds a confidence score threshold, wherein when the confidence score associated with any of the capabilities associated with built-in AI productivity tool-enablable software applications and plug-in AI productivity tool-enablable software applications does not meet or exceed the confidence score threshold, the associated capabilities associated with built-in AI productivity tool-enablable software applications and plug-in AI productivity tool-enablable software applications are not placed within a queue for execution as capability intent actions responsive to the user query input.

3. The information handling system of claim 1, wherein the policy metadata for responsive capabilities associated with each built-in AI productivity tool-enablable software applications and each plug-in AI productivity tool-enablable software applications is identified by the capability orchestrator software application from a capability policy database to control execution or elimination of plural responsive capabilities from a first manufacturer AI productivity tool module coordinating the built-in AI productivity tool-enablable software applications and from a second software vendor AI productivity tool module coordinating the plug-in AI productivity tool-enablable software applications.

4. The information handling system of claim 1 further comprising:
the policy metadata identifying requirements of execution for which other available capabilities are allowed or not allowed to be executed when a first responsive capability associated with a first built-in AI productivity tool-enablable software applications or a first plug-in AI productivity tool-enablable software applications is executed.

5. The information handling system of claim 1 further comprising:
the policy metadata identifying requirements of execution for which other available capabilities are required to be executed when a first responsive capability associated with a first built-in AI productivity tool-enablable software applications or a first plug-in AI productivity tool-enablable software applications is executed.

6. The information handling system of claim 1 further comprising:
the policy metadata identifying requirements of execution for which of the ranked, responsive capabilities associated with the built-in AI productivity tool-enablable software applications do or do not have priority over the ranked, responsive capabilities associated with the plug-in AI productivity tool-enablable software applications.

7. The information handling system of claim 1 further comprising:
the hardware processor to execute computer-readable program code instructions of a capability discovery software application to access hardware drivers associated with one or more hardware devices in the information handling system to discover the plurality of capabilities associated with each built-in AI productivity tool-enablable software applications.

8. The information handling system of claim 1 further comprising:
the hardware processor to execute computer-readable program code instructions of a capability discovery software application to receive .json files from hardware drivers associated with each of the built-in AI productivity tool-enablable software applications and plug-in AI productivity tool-enablable software applications describing a name and version and descriptions of each of the capabilities associated with the built-in AI productivity tool-enablable software applications and the plug-in AI productivity tool-enablable software applications.

9. A method of prioritizing among built-in and plug-in capabilities in response to a user query input comprising:
executing, with the hardware processor, computer-readable program code instructions of a first artificial intelligence (AI) productivity tool software module and a second AI productivity tool software module to receive the user-query input and invoke a plurality of machine learning (ML) model algorithms to identify a plurality of responsive capabilities associated with built-in AI productivity tool-enablable software applications of the first AI productivity tool software module and plug-in AI productivity tool-enablable software applications of the second AI productivity tool software module executable on an information handling system that are responsive to the user-query input;
executing, with the hardware processor, the computer-readable program code instructions of a capability orchestrator software application to determine policy metadata identifying requirements of execution for a portion of the responsive capabilities and to rank each of the plurality of responsive capabilities based on a confidence score generated by the capability orchestrator software application from similarity correlation matching of the user query input with the responsive capabilities; and
executing, with the hardware processor, the computer-readable program code instructions of the capability orchestrator software application to prioritize each of the ranked plurality of responsive capabilities associated with the built-in AI productivity tool-enablable software applications and the plug-in AI productivity tool-enablable software applications based on the policy metadata associated with the ranked, responsive capabilities to identify and execute at least one responsive capability intent action to the user query input.

10. The method of claim 9 further comprising:
executing, with a hardware processor, computer-readable program code instructions of a capability discovery software application to identify available capabilities associated with the built-in AI productivity tool-enablable software applications and the plug-in AI productivity tool-enablable software applications executable on the information handling system.

11. The method of claim 9 further comprising:
executing, with the hardware processor, computer-readable program code instructions of the capability orchestrator software application to determine if the confidence score meets or exceeds a confidence score threshold, wherein when the confidence score associated with any available capabilities associated with built-in AI productivity tool-enablable software applications and plug-in AI productivity tool-enablable software applications does not meet or exceed the confidence score threshold, those available capabilities are not placed within a queue for execution as the ranked, responsive capabilities.

12. The method of claim 9 further wherein the first AI productivity tool software module is a first manufacturer AI productivity tool module coordinating the built-in AI productivity tool-enablable software applications and the second AI productivity tool software module is a second software vendor AI productivity tool module coordinating the plug-in AI productivity tool-enablable software applications at the information handling system.

13. The method of claim 9 further comprising:
the policy metadata describing which other available capabilities are allowed or not allowed to be executed when a first responsive capability associated with a first built-in AI productivity tool-enablable software applications or a first plug-in AI productivity tool-enablable software applications are executed.

14. The method of claim 9 further comprising:
the policy metadata identifying requirements of execution for whether other available capabilities are required to be executed when a first responsive capability associated with a first built-in AI productivity tool-enablable software application or a first plug-in AI productivity tool-enablable software application is executed.

15. The method of claim 9 further comprising:
the policy metadata identifying requirements of execution for which of the ranked, responsive capabilities associated with the built-in AI productivity tool-enablable software applications do or do not have priority over the ranked, responsive capabilities associated with the plug-in AI productivity tool-enablable software applications.

16. An information handling system to prioritize between built-in and plug-in capabilities executed at the information handling system in response to a user query input comprising:
a hardware processing device, a data storage device, and a power management unit (PMU) to provide power to the hardware processing device and data storage device;
the hardware processor to execute computer-readable program code instructions of a first artificial intelligence (AI) productivity tool software module and a second AI productivity tool software module to receive the user-query input and invoke a plurality of machine learning (ML) model algorithms to identify a plurality of responsive capabilities from available capabilities associated with built-in AI productivity tool-enablable software applications of the first AI productivity tool software module and plug-in AI productivity tool-enablable software applications of the second AI productivity tool software module that are responsive to the user-query input;
the hardware processor to execute the computer-readable program code instructions of a capability orchestrator software application to determine policy metadata identifying requirements of execution for at least one responsive capability and to rank each of the plurality of responsive capabilities based on a confidence score generated by the capability orchestrator software application from similarity correlation matching of the user query input with the responsive capabilities; and
the hardware processor to execute the computer-readable program code instructions of the capability orchestrator software application to prioritize each of the ranked plurality of responsive capabilities associated with the built-in AI productivity tool-enablable software applications and the plug-in AI productivity tool-enablable software applications based on the policy metadata associated with the ranked, responsive capabilities to identify and execute at least one responsive capability intent action to the user query input.

17. The information handling system of claim 16 further comprising:
the policy metadata identifying requirements of execution for which other responsive capabilities are not allowed to be executed when a first responsive capabilities associated with a first built-in AI productivity tool-enablable software applications or a first plug-in AI productivity tool-enablable software applications is executed based on similarity categorization of the other responsive capabilities.

18. The information handling system of claim 16 further comprising:
the policy metadata describing which other available capabilities are allowed or not allowed to be executed when each of the responsive capabilities associated with built-in AI productivity tool-enablable software applications or the plug-in AI productivity tool-enablable software applications are executed.

19. The information handling system of claim 16 further comprising:
the policy metadata identifying requirements of execution for which other available capabilities are required to be executed when a first responsive capability associated with a first built-in AI productivity tool-enablable software applications or a first plug-in AI productivity tool-enablable software applications is executed.

20. The information handling system of claim 16 further comprising:
the policy metadata identifying requirements of execution for which of the ranked, responsive capabilities associated with the built-in AI productivity tool-enablable software applications do or do not have priority over the ranked, responsive capabilities associated with the plug-in AI productivity tool-enablable software applications.
